(19) United States
(12) Patent Application Publication
(10) Pub. No.: US 2006/0175764 A1
(43) Pub. Date: Aug. 10, 2006

(54) Gasket

(76) Inventor: Katsunori Matsuki, Okayama (JP)

Correspondence Address: WENDEROTH, LIND & PONACK, L.L.P., 2033 K STREET N. W., SUITE 800, WASHINGTON, DC, 20006-1021, US

(21) Appl. No.: 11/375,132

(22) Filed: Mar. 15, 2006

Related U.S. Application Data
(63) Continuation of application No. 10/902,079, filed on Jul. 30, 2004.
Application No. 10/902,079 is a continuation of application No. 10/401,882, filed on Mar. 31, 2003, now abandoned.

(30) Foreign Application Priority Data
Mar. 29, 2002 (JP) 2002-094167

(51) Int. Cl. F02F 11/00

(52) U.S. Cl. 277/598

(57) ABSTRACT

A gasket is to be mounted within a groove knurled in a seal surface of a cover member, and is to be used for sealing between the cover member and a block member closely attached to the seal surface of the cover member, wherein the gasket has at least one satin finished surface portion on its side wall.

This is a continuation application of Ser. No. 10/401,882, filed Mar. 31, 2003, now abandoned.

### BACKGROUND OF THE INVENTION

1. Field of the Invention

The present invention relates to a sealing member (for example, a gasket) which seals between a cover member (for example, a cylinder head cover) in an engine, mounted on a motor vehicle or the like, and a corresponding member (for example, a cylinder head). Particularly, the present invention relates to an improvement of mounting operability for attaching a gasket to an annular groove knurled in the cover member.

2. Description of the Related Art

Conventionally, a sealing member (for example, a gasket), which seals between a cover member such as a head cover, an intake manifold, and the like of an engine mounted on a motor vehicle or the like, and a block member such as a cylinder head, a cylinder block, and the like, employs an annular gasket formed from an elastic material such as synthetic rubber, cork, synthetic resin, and the like and has a rectangular or round cross sectional shape.

When this conventionally used gasket is inserted into an annular groove knurled in a seal surface of the cover member from a leading end side at a time of being mounted, a bottom surface side of the gasket opposing the leading end side is exposed from the annular groove in a state in which most portions thereof are attached within the annular groove.

A corresponding member, such as the cylinder head or the like, is in contact with an exposed bottom portion.

In this case, when fastening the cover member and the corresponding member using a fastening device such as a bolt or the like at a time of fastening, the gasket is compressed, and is elastically deformed such that the cover member and corresponding member are closely and strongly attached to each other, whereby a required sealing operation is complete. This fastening is generally performed with a fastening torque of about 5 to 10 N·m.

However, the conventionally used annular gasket mentioned above cannot respond to requirements such as a safety attachment at a time of being mounted, which would prevent the gasket from falling down at a time of being fastened and the like, during an assembly operation.

That is, corresponding to a recent weight saving requirement, the gasket is structured such that it is formed into an O-ring shape having a narrow and vertically long cross section. When it is intended to attach a gasket formed in this manner within the annular groove knurled in the seal surface of the cover member, it is difficult to rapidly and securely attach the gasket within the annular groove knurled in the cover member because of its narrow shape.

Furthermore, the gasket, which is attached within the annular groove knurled in the seal surface of the cover member and is formed in the O-ring shape having the narrow and vertically long cross section mentioned above, is easily deformed at an outer portion of the annular groove and easily falls down into a transverse position in order to be fastened, at time of being fastened, because of its vertically long shape.

Furthermore, in an engine assembly line, after the gasket is mounted to the cover member, the cover member is reversed, and the fastening step mentioned above to the cylinder head or the like is performed. Then, in a case that a dropout prevention member provided in the gasket is insufficient, there is a possibility that any problems, such as a seal defect caused by a dropout or displacement of the gasket, may be generated. In addition, a more serious breakage may be sometimes generated due to dropout or displacement of the gasket.

To the contrary, when a dropout prevention member provided on the gasket, for example, a projecting portion arranged on a side wall of the gasket, is made large, characteristics of insertion into the annular groove are deteriorated.

Therefore, a gasket structure is required, which is suitable for a work, so that it can be rapidly and easily mounted within the annular groove provided onto the seal surface of the cover member as well as securely mounted within the annular groove.

In recent engine assembly lines, there has even been generated a requirement for automatically attaching the gasket within the annular groove knurled in the cover member by use of a mounting robot or the like, in further advance of the matter mentioned above.

However, since the gasket having the narrow cross section mentioned above and formed in the vertical O-ring shape is inferior in terms of a shape maintaining property, this gasket cannot be applied for automatic attachment, which is performed in recent engine assembly lines as mentioned above.

### SUMMARY OF THE INVENTION

Taking the defects mentioned above into consideration, an object of the present invention is to provide a gasket that has an increased sealing performance, and that is suitable for a work so that it can be rapidly and easily mounted within a groove knurled in a seal surface of a cover member as well as securely mounted within the groove.

In order to solve the problems mentioned above, one aspect of the present invention provides a gasket, especially an elastic gasket, which is mounted within a groove knurled in a seal surface of a cover member and is used for sealing between the cover member and a block member closely attached to the seal surface of the cover member, wherein the gasket has at least one satin finished surface portion on its side wall.

Another aspect of the present invention provides a gasket, wherein the gasket has at least one projecting portion provided on its side wall, and a satin finished surface portion is formed on a surface of the projecting portion.

Still another aspect of the present invention provides a gasket, wherein the gasket has at least one corner portion, and a satin finished surface portion is formed on a surface of the corner portion.

Still another aspect of the present invention provides a gasket, wherein the gasket has at least one arch portion, and a satin finished surface portion is formed on a surface of a base portion in a rising portion of the arch portion.

In the before described gasket of the present invention, the gasket is molded using a metal mold cavity used for molding gaskets and having at least one rough surface portion, formed by a surface roughening process, on its inner wall surface.

In accordance with the present invention, the satin finished surface portion or portions are formed on a part or on some parts of a side wall of the gasket. Since this satin finished surface portion has a small frictional force, it is possible to smoothly and safely insert the gasket into a groove under applied pressure and mount the gasket within an annular groove knurled in a seal surface of a cover member. Furthermore, when a gasket of the present invention has been mounted within the groove, it transmits its rebound resilience directly to the groove in a static state and does not generate slack although the satin finished surface portion, which has a small frictional force, is provided. So, it is possible to achieve sufficient fixing force and seal performance.

In the gasket, in accordance with the present invention, the satin finished surface portion is provided on the side surface of the gasket as mentioned above. Accordingly, when inserting and mounting the gasket within the annular groove of the cover member, the satin finished surface portion performs a guiding function, thereby making it possible to very smoothly insert the gasket into the groove, so that it is possible to eliminate a risk of an imperfect mounting.

Accordingly, when using the gasket of the present invention, it is possible to employ a robot for performing automatic mounting operations or the like in engine assembly lines.

### BRIEF DESCRIPTION OF THE DRAWINGS

FIG. 1 is a perspective view that shows an embodiment of a gasket in accordance with the present invention; and

FIG. 2 is a cross sectional view that shows an example of a fastening process between a cover member and a corresponding member, in which the gasket of the present invention is mounted within a groove of the cover member.

### DESCRIPTION OF PREFERRED EMBODIMENTS

A description will be given below of a preferable embodiment in accordance with the present invention with reference to the accompanying drawings.

A gasket 3 of the present invention is attached to a groove portion 11 (for example, mounted within an annular groove knurled in a seal surface of a cover member 1 (for example, a cylinder head cover)) in an engine or the like for a motor vehicle, as shown in FIG. 2. This gasket 3 is used for sealing between the cover member 1 and a block member 2 such as a cylinder head or a cylinder block closely attached to the seal surface of the cover member 1.

The gasket 3 is formed from an elastic material, for example, a synthetic rubber material, a synthetic resin material or the like, in accordance with a conventionally known manner. The material for the gasket 3 used here includes, for example, a rubber material, a thermosetting elastomer, a resin material or the like. As the rubber material, it is possible to employ a butyl rubber, a styrene-butadiene copolymer, an ethylene-vinyl acetate copolymer, an ethylene-methyl acrylate copolymer, an ethylene-ethyl acrylate copolymer, a butadiene rubber, a nitrile rubber, a hydrogenation nitrile rubber, an acrylic rubber, a silicon rubber, a fluorine-contained rubber, a phlorosilicon rubber, an ethylene propylene rubber, and the like.

The gasket 3 of the present invention can be formed by employing the material as mentioned above and using a metal mold cavity, for molding gaskets, having at least one rough surface portion on an inner wall surface of the metal mold cavity. This rough surface portion can be formed by any surface roughening process.

That is to say, although it is not shown, the before described metal mold cavity for molding a gasket is structured such that a surface roughening process is applied to the desired portion or portions on the inner wall surface of the metal mold cavity by a shot blast, a peening process, a knurling process or the like. The rough surface portion is formed on a part of or some parts of the inner wall surface of the metal mold cavity for molding gaskets.

When forming the gasket 3 of the present invention by using the before described metal mold cavity for molding gaskets, the rough surface portion or portions formed on the inner wall surface of the metal mold cavity are mapped onto a side wall of the gasket 3 when molded, whereby a satin finished surface portion or portions are formed on the side wall of the gasket 3 by mapping the rough surface portion or portions of the metal mold cavity.

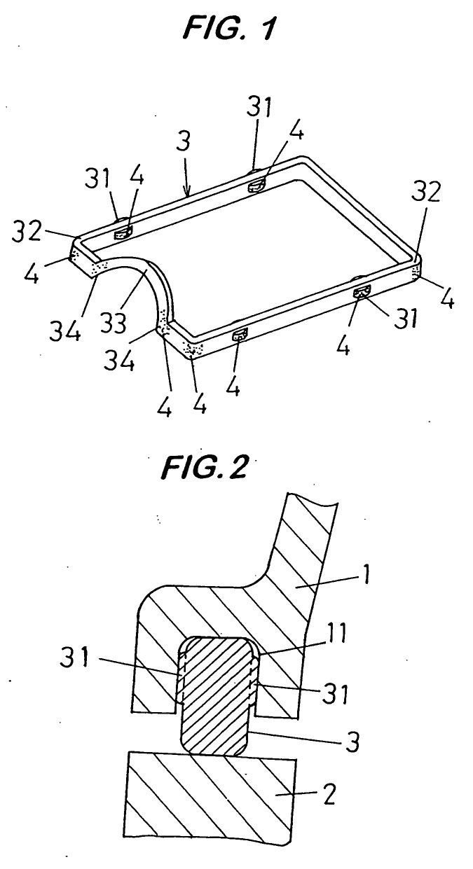

The gasket 3, in accordance with the present invention, can be modified to a configuration in which one or a plurality of projecting portions 31 are provided on its side wall. In the embodiment illustrated in FIG. 1, the projecting portions 31 are arranged at four portions.

Furthermore, the gasket 3, in accordance with the present invention, can be modified to a configuration in which one or a plurality of corner portions 32 are provided. In the embodiment illustrated in FIG. 1, the corner portions are arranged at four locations.

Furthermore, the gasket 3, in accordance with the present invention, can be modified to a configuration in which an arch portion 33 is provided. In the embodiment illustrated in FIG. 1, one arch portion 33 curved toward a central direction of the gasket 3 is formed.

Each projecting portion 31, arranged on the side wall of the gasket 3, is provided for a purpose of preventing the gasket from dropping out of the groove portion 11. Accordingly, it is formed slightly wider than the annular groove of the cover member 1, as illustrated in FIG. 2, in order to apply a rebound resilience. Thus, the structure is made such that it is hard for the gasket 3, inserted under any applied pressure and mounted within the annular groove of the cover member 1, to drop out therefrom.

Therefore, it is not easy to insert and attach a portion on which the projecting portion 31 is arranged, on the side wall of the gasket 3, within the annular groove portion 11. That is, in a position in which the projecting portion 31 is arranged on the side wall of the gasket 3, a high insertion resistance may be provided when the gasket 3 is inserted into the annular groove 11 of the cover member 1 under applied pressure.

Also, there is a possibility that a high insertion resistance may be caused at corner portion 32 of the gasket 3 due to any elongation or contraction, generated in accordance with a fitting state of portions other than the corner portion 32.

Furthermore, in a base portion 34 of the rising portion in the arch portion 33, there is a possibility that a high insertion resistance may be caused in the same manner.

The gasket 3, in accordance with the present invention, is formed, as mentioned above, using a metal mold cavity for molding gaskets in which a rough surface portion or portions are formed on a part or some parts of an inner wall surface of the metal mold cavity. The rough surface portions can be previously formed on the inner wall surface of the metal mold cavity in correspondence to positions in which the projecting portions 31, the corner portions 32, and base portions 34 of the rising portions in the arch portion 33 are formed on the gasket 3 after it is formed. If the metal mold cavity is formed as before described, the rough surface portions are mapped, and satin finished surface portions 4 can be formed on surfaces of the projecting portions 31, the corner portions 32, and the base portions 34 of the rising portions in the arch portion 33 that are provided in the gasket 3 after it is formed.

In the portions in which satin finished surface portions 4 are formed, a frictional force at a time of inserting the gasket 3 into the annular groove 11 of the cover member 1 is reduced, and insertion resistance under applied pressure becomes small.

Then, by employing the gasket 3 in which the satin finished surface portions 4 are formed on the surface of the projecting portions 31, the corner portions 32, and the base portions 34 of the rising portions in the arch portion 33, which particularly have a high insertion resistance as previously described, it is possible to decrease insertion resistance under applied pressure at the time of inserting the gasket 3 into the annular groove 11 of the cover member 1. Thereby, it is possible to achieve a smooth, stable, and safe attachment and mounting.

In the gasket of the present invention, there is a situation when the projecting portion 31 arranged on the side wall of the gasket 3 may be provided for a purpose of preventing the gasket from falling down despite a main purpose of preventing the gasket from dropping out. A projecting portion 31 arranged for the purpose of preventing the gasket from falling down is generally smaller than a projecting 31 arranged for the purpose of preventing the gasket from dropping out. If a satin finished surface portion 4 is provided on the surface of the projecting portion 31 provided for the purpose of preventing the gasket from falling down, it is still possible to decrease the insertion resistance at a time of inserting the gasket 3 under applied pressure into the annular groove portion 11 of the cover member 1, and it is possible to achieve smooth, stable, and safe attachment and mounting.

Each satin finished surface portion 4 in the gasket 3 of the present invention is basically provided at a portion in which insertion resistance at a time of inserting the gasket 3 into the annular groove portion 11 of the cover member 1 under applied pressure is relatively large. Accordingly, for example, in an irregularly shaped gasket or a modified shaped gasket (not shown) or the like, it goes without saying that the satin finished surface portion 4 is arranged not only on surfaces of projecting portions 31, corner portions 32, and base portions 34 of rising portions in arch portion 33 mentioned above, but also on any portions having a high insertion resistance.

Although the preferred embodiment of the present invention is described above using the attached figures, it is to be understood that the invention is not limited to the forms disclosed in the previously described embodiment, and various modifications and variations may be made within the technical scope of the invention as set forth in the appended claims.

What is claimed is:

1. A gasket to be mounted within a groove in a seal surface of a cover member, and to be used for sealing between the cover member and a block member closely attached to the seal surface of the cover member, said gasket comprising:
a side wall;
at least one satin finished surface portion on said side wall; and
at least one non-satin finished surface portion on said side wall.

2. The gasket according to claim 1, wherein
said side wall includes at least one projecting portion, with said at least one satin finished surface portion being on a surface of said at least one projecting portion.

3. The gasket according to claim 2, wherein said at least one projecting portion comprises at least two projecting portions,
such that said at least one satin finished surface portion comprises at least two satin finished surface portions, with each of said at least two satin finished surface portions being on a surface of a corresponding one of said at least two projecting portions, and
such that said at least one non-satin finished surface portion is between said at least two projecting portions.

4. The gasket according to claim 3, wherein
said gasket is produced by molding material within a metal mold cavity having rough portions, provided by performing a surface roughening process, on an inner wall surface of said metal mold cavity, with said rough portions corresponding to said at least two satin finished surface portions, respectively.

5. The gasket according to claim 2, wherein
said gasket is produced by molding material within a metal mold cavity having a rough portion, provided by performing a surface roughening process, on an inner wall surface of said metal mold cavity, with said rough portion corresponding to said at least one satin finished surface portion.

6. The gasket according to claim 3, wherein said side wall further includes at least two corner portions,
such that said at least one satin finished surface portion further comprises at least two additional satin finished surface portions, with each of said at least two additional satin finished surface portions being on a surface of a corresponding one of said at least two corner portions, and
such that said at least one non-satin finished surface portion comprises plural non-satin finished surface portions between said at least two projecting portions and said at least two corner portions.

7. The gasket according to claim 6, wherein said side wall further includes at least one arch portion,
such that said at least one satin finished surface portion further comprises another satin finished surface portion on a surface of a base portion at a rising portion of said at least one arch portion, and
such that said at least one non-satin finished surface portion further comprises another non-satin finished surface portion on a part of said at least one arch portion other than said base portion.

8. The gasket according to claim 7, wherein
said gasket is produced by molding material within a metal mold cavity having rough portions, provided by performing a surface roughening process, on an inner wall surface of said metal mold cavity, with said rough portions corresponding to said at least two satin finished surface portions, said at least two additional satin finished surface portions, and said another satin finished surface portion, respectively.

9. The gasket according to claim 6, wherein
said gasket is produced by molding material within a metal mold cavity having rough portions, provided by performing a surface roughening process, on an inner wall surface of said metal mold cavity, with said rough portions corresponding to said at least two satin finished surface portions, and said at least two additional satin finished surface portions, respectively.

10. The gasket according to claim 2, wherein
said gasket is produced by molding material within a metal mold cavity having a rough portion, provided by performing a surface roughening process, on an inner wall surface of said metal mold cavity, with said rough portion corresponding to said at least one satin finished surface portion.

11. The gasket according to claim 1, wherein
said side wall includes at least one corner portion, with said at least one satin finished surface portion being on a surface of said at least one corner portion.

12. The gasket according to claim 11, wherein
said gasket is produced by molding material within a metal mold cavity having a rough portion, provided by performing a surface roughening process, on an inner wall surface of said metal mold cavity, with said rough portion corresponding to said at least one satin finished surface portion.

13. The gasket according to claim 11, wherein said at least one corner portion comprises at least two corner portions,
such that said at least one satin finished surface portion comprises at least two satin finished surface portions, with each of said at least two satin finished surface portions being on a surface of a corresponding one of said at least two corner portions, and
such that said at least one non-satin finished surface portion is between said at least two corner portions.

14. The gasket according to claim 13, wherein
said gasket is produced by molding material within a metal mold cavity having rough portions, provided by performing a surface roughening process, on an inner wall surface of said metal mold cavity, with said rough portions corresponding to said at least two satin finished surface portions, respectively.

15. The gasket according to claim 1, wherein
said side wall includes at least one arch portion, with said at least one satin finished surface portion being on a surface of a base portion at a rising portion of said at least one arch portion.

16. The gasket according to claim 15, wherein
said gasket is produced by molding material within a metal mold cavity having a rough portion, provided by performing a surface roughening process, on an inner wall surface of said metal mold cavity, with said rough portion corresponding to said at least one satin finished surface portion.

17. The gasket according to claim 15, wherein
said at least one non-satin finished surface portion comprises a non-satin finished surface portion on a part of said at least one arch portion other than said base portion.

18. The gasket according to claim 17, wherein
said gasket is produced by molding material within a metal mold cavity having a rough portion, provided by performing a surface roughening process, on an inner wall surface of said metal mold cavity, with said rough portion corresponding to said at least one satin finished surface portion.

19. The gasket according to claim 1, wherein
said gasket is produced by molding material within a metal mold cavity having a rough portion, provided by performing a surface roughening process, on an inner wall surface of said metal mold cavity, with said rough portion corresponding to said at least one satin finished surface portion.

20. The gasket according to claim 1, wherein
said at least one satin finished surface portion on said side wall comprises at least two satin finished surface portions, with said at least one non-satin finished surface portion being between said at least two satin finished surface portions.

21. The gasket according to claim 6, wherein
said gasket is produced by molding material within a metal mold cavity having rough portions, provided by performing a surface roughening process, on an inner wall surface of said metal mold cavity, with said rough portions corresponding to said at least two satin finished surface portions, respectively.
